(19) United States
(12) Patent Application Publication
(10) Pub. No.: US 2014/0246886 A1
(43) Pub. Date: Sep. 4, 2014

(54) AIRCRAFT DIVAN CONVERTIBLE TO A BUNK BED

(71) Applicant: BOMBARDIER INC., Dorval (CA)

(72) Inventors: David Savard, Ste-Marthe-Sur-Le-lac (CA); Rene Bardier, Montreal (CA); Martin Larose, Pointe-Claire (CA); Michael Gillis, Dollard des Ormeaux (CA); Michel Tremblay, Ste-Dorothee (CA); Michael Oleson, Parkland, FL (US); Alfredo Suarez, Miramar, FL (US)

(21) Appl. No.: 14/349,507

(22) PCT Filed: Oct. 5, 2012
(86) PCT No.: PCT/US12/58929

§ 371 Date: Apr. 3, 2014

Related U.S. Application Data
(60) Provisional application No. 61/544,494, filed on Oct. 7, 2011.

(51) Int. Cl. B64D 11/06

(52) U.S. Cl. CPC B64D 11/06; B64D 2011/0069
USPC 297/62

(57) ABSTRACT

A divan includes a seating surface and a backrest. In a first configuration, the backrest is positioned adjacent to the seating surface to support a person's back while the person is seated on the seating surface. In the first configuration, the seating surface is disposed at a first predetermined height above a horizontal plane. In a second configuration, the backrest establishes an upper bunk above the seating surface. In the second configuration, the seating surface establishes a lower bunk beneath the upper bunk. In the second configuration, the seating surface is disposed at a second predetermined height that is lower than the first predetermined height.

### CROSS-REFERENCE TO RELATED APPLICATION(S)

This application relies for priority on U.S. Provisional Patent Application Ser. No. 61/544,494, entitled “AIRCRAFT DIVAN CONVERTIBLE TO A BUNK BED,” filed 7 Oct. 2011, which is hereby incorporated by reference in its entirety.

### FIELD OF THE INVENTION

The present invention concerns furniture for moving vehicles, particularly aircraft. The present invention concerns a divan (also referred to as a couch, lounge, settee or sofa) that may be converted into a bunk bed.

### DESCRIPTION OF THE RELATED ART

There are numerous rules and regulations that encompass air travel. Among these many rules, regulatory agencies worldwide, commercial carriers, and private carriers frequently impose restrictions on the number of hours that a particular flight crew may work before being required to rest. As should be apparent, such restrictions are designed to prevent crews from working to the point (or beyond the point) of exhaustion.

Modern aircraft are designed to travel considerably longer distances than aircraft in the past. While distances for aircraft have increased, the operational speed of most aircraft has remained relatively unchanged. As a result, while modern aircraft are able to fly to a more remote destination, it takes proportionately longer for the aircraft to reach that further destination.

To comply with existing regulations concerning the number of hours a particular crew may fly, it has become increasingly necessary for aircraft designers to incorporate sleeping and rest areas in aircraft. When equipped with such rest areas, one crew remain working while to the second crew sleeps.

Numerous solutions to this problem have been implemented by various aircraft manufacturers for various airplane designs.

As should be immediately apparent to those skilled in the art, large, commercial aircraft are more easily modified to include a crew rest area than smaller aircraft, simply because they have more room in which to accommodate resting crews. For those aircraft that have not been modified to incorporate a separate crew sleeping area, designers often provide a privacy curtain, which permits a section of the passenger compartment to be cordoned off, permitting crew members to rest during a flight.

For some aircraft designs, separate crew quarters are provided.

U.S. Patent Application Publication No. 2011/0114789 (hereinafter “the '789 Application”) describes a unit for accommodating members of an aircraft crew. The crew rest compartment, which is illustrated in FIG. 1, includes several units 101, 102, 103, 104, 105 that encompass sleeping and stowage compartments. (The '789 Application at paragraph [0095].) The crew rest compartment is designed to be separate from the passenger area of the aircraft.

Similarly, U.S. Pat. No. 3,898,704 (hereinafter “the '704 Patent”) describes a convertible seat-bed equipment that may be provided to permit crew members to rest and sleep in privacy during long flights. (The '704 Patent at col. 1, lines 23-24.) The '704 Patent takes advantage of the space adjacent to the door 12 through which passengers enter and exit the aircraft. (The '704 Patent at col. 2, lines 33-36.) Specifically, a seat is provided in the entry/exit area that may be converted from a seat, where the occupant is upright, into an upper bunk bed. A lower bunk bed may be erected beneath the upper bed by assembling elements that are stored behind the seat. (See, e.g., the '704 Patent at FIGS. 1 and 2; see also the '704 Patent at col. 2, line 62, through col. 3, line 17.)

In U.S. Pat. No. 6,152,400 (hereinafter “the '400 Patent”), a sleeping compartment is provided in the belly of the aircraft, in the space beneath the cabin floor 12 of the aircraft. (See, e.g., the '400 Patent at FIGS. 2 and 4.)

In U.S. Pat. No. 6,073,883 (hereinafter “the '883 Patent”), a sleeping compartment is provided above the passenger area, in the space above and between the overhead storage bins on the aircraft. (See, e.g., the '883 Patent at FIGS. 2 and 4.)

In U.S. Pat. No. 7,070,149 (hereinafter “the '149 Patent”), seats are described that are convertible into sleeper bunks. Specifically, in one configuration, which is shown in FIG. 2, the backrests of seats on an aircraft form a top bunk while the seat cushions are configured to form a bottom bunk. In an alternative embodiment, which is shown in FIG. 3, the seat cushions are raised to form the second bunk, thereby providing room for a third bunk on the floor of the aircraft. (See the '149 Patent at FIGS. 2 and 3.)

Noticeably absent from the prior art are solutions to the problem of a sleeping area provided in smaller aircraft. Understandably, the solutions proposed by the above-identified references, which are designed to be incorporated into larger aircraft, are not easily incorporated into smaller jet aircraft due to space constraints and considerations.

In smaller aircraft, such as business or personal aircraft, there are more limited design options when incorporating a rest area into the aircraft cabin.

Accordingly, the prior art leaves room for the development of aircraft furniture that may accommodate crew members when at rest during extended length flights.

It is noted that the prior art includes examples of couches that are convertible to bunk beds.

For example, Croatian Patent No. HR P20030927 describes a couch that is convertible into bunk beds by pivoting a backrest into a horizontal position. The seating area becomes the bottom bunk and the backrest becomes the top bunk.

Similarly, U.S. Pat. No. 2,854,672 describes a folding couch bunk bed with a similar arrangement that may be used in camping trailers and the like.

Despite these examples of prior art, which are not presented in the context of a crew rest area in an aircraft, the prior art does not offer a suitable solution when addressing the concerns of a crew rest area for a small jet aircraft.

### SUMMARY OF THE INVENTION

The present invention seeks to address one or more of the deficiencies noted with respect to the prior art.

Specifically, the present invention provides a divan for an aircraft that may accommodate person(s) thereon in a seated manner. The divan may be converted to a bunk bed that accommodates crew members by providing a convenient sleeping area within the aircraft cabin.

The present invention, therefore, provides both a convenient crew and/or passenger seating area, which doubles as a crew/passenger sleeping facility.

The divan of the present invention, when configured as a sleeping facility, maximizes sleeping space volume while preserving a modest footprint within the aircraft cabin.

The divan of the present invention provides this sleeping facility within the height restrictions of the aircraft cabin, which is defined at least in part by the sidewall (or fuselage wall) of the aircraft.

One aspect of the divan of the present invention permits the creation of upper and lower bunk beds within the height restrictions of an aircraft by permitting, among other features, the lowering of a height of the seating surface, which permits the establishment of a lower bunk, despite the limited space adjacent to the aircraft sidewall.

The present invention provides a divan, that includes a seating surface and a backrest. In a first configuration, the backrest is positioned adjacent to the seating surface to support a person's back while the person is seated on the seating surface. In the first configuration, the seating surface is disposed at a first predetermined height above a horizontal plane. In a second configuration, the backrest establishes an upper bunk above the seating surface. In the second configuration, the seating surface establishes a lower bunk beneath the upper bunk. In the second configuration, the seating surface is disposed at a second predetermined height that is lower than the first predetermined height.

In one contemplated embodiment of the divan of the present invention, the divan includes a vertical frame element, with top and bottom ends, disposed adjacent to the seating surface and the backrest. The backrest is pivotally connected adjacent to the top end of the vertical frame element. The seating surface is slidably connected adjacent to the bottom end of the vertical frame element.

In another contemplated embodiment, the seating surface also is pivotally connected adjacent to the bottom end of the vertical frame element.

The present invention also provides for a divan that includes an extension surface pivotally connected to the backrest. The extension surface is lockable into a position adjacent to the backrest to increase a width of the backrest when in the second configuration.

With respect to one embodiment of the divan of the present invention, in the first configuration, the backrest forms a first angle with respect to the horizontal plane, the seating surface forms a second angle with respect to the horizontal plane, and the first and second angles are greater than or equal to 0 degree.

In the second configuration, it is contemplated that the backrest is parallel to the horizontal plane and the seating surface is parallel to the horizontal plane.

The present invention also contemplates an embodiment where a seating frame supports the seating surface, a lower frame is positioned adjacent to the seating frame, and a scissor connects the seating frame to the lower frame, thereby permitting transition of the seating surface between the first configuration and the second configuration.

It is contemplated that the scissor includes a first scissor element with a first end and a second end and a second scissor element with a third end and a fourth end. The first and second scissor elements are pivotally connected to one another at positions intermediate to the first and second and third and fourth ends, respectively. The first end is pivotally connected to the seating frame, the second end is pivotally and slidingly connected to the lower frame, the third end is pivotally and slidingly connected to the seating frame, and the fourth end is pivotally connected to the lower frame.

The divan of the present invention also may include at least one bracket disposed at a predetermined height such that the bracket supports the upper bunk when in the second configuration.

It is contemplated that the divan will incorporate a plurality of legs to support the lower frame. If so, the plurality of legs are anticipated to be connected to seating tracks disposed within a floor of an aircraft cabin.

In another contemplated embodiment of the present invention, the divan includes at least two seating surfaces disposed adjacent to one another in a side-by-side arrangement and at least two backrests disposed adjacent to one another in a side-by-side arrangement. In a first configuration, the backrests are positioned adjacent to the seating surfaces to support a person's back while the person is seated on at least one of the seating surfaces. In the first configuration, the seating surfaces are disposed at a first predetermined height above a horizontal plane. In a second configuration, the backrests establish an upper bunk above the seating surfaces. In the second configuration, the seating surfaces establish a lower bunk beneath the upper bunk. In the second configuration, the seating surfaces are disposed at a second predetermined height that is lower than the first predetermined height.

In this contemplated embodiment, the divan may include at least two vertical frame elements, with top and bottom ends, disposed adjacent to the seating surfaces and the backrests The backrests may be pivotally connected adjacent to the top ends of the vertical frame elements and the seating surfaces may be slidably connected adjacent to the bottom ends of the vertical frame elements.

In a further contemplated embodiment, the seating surfaces also may be pivotally connected adjacent to the bottom end of the vertical frame element.

An additional embodiment of the divan of the present invention includes an extension surface pivotally connected to each backrest. Each extension surface is lockable into a position adjacent to each backrest to increase a width of each backrest when in the second configuration.

It is contemplated that, in the first configuration, the backrests form a first angle with respect to a vertical line perpendicular to the horizontal plane, the seating surfaces form a second angle with respect to the horizontal plane, and the first and second angles are greater than or equal to 0 degree.

In the second configuration, it is contemplated that the backrests are parallel to the horizontal plane, and the seating surfaces are parallel to the horizontal plane.

The divan of the present invention also may include a seating frame supporting each seating surface, a lower frame positioned adjacent to each seating frame, and at least two scissors connecting each seating frame to each lower frame, thereby permitting transition of the seating surfaces between the first configuration and the second configuration.

The divan may be constructed so that the scissors each comprise a first scissor element with a first end and a second end and a second scissor element with a third end and a fourth end. The first and second scissor elements may be pivotally connected to one another at positions intermediate to the first and second and third and fourth ends, respectively. The first end may be pivotally connected to the seating frame. The second end may be pivotally and slidingly connected to the lower frame. The third end may be pivotally and slidingly connected to the seating frame. The fourth end may be pivotally connected to the lower frame.

Additionally, it is contemplated that the divan of the present invention may include at least two brackets disposed at a predetermined height such that the brackets support the upper bunk when in the second configuration, and an upper bunk connector to connect the seating surfaces to one another when in the second configuration.

As before, it is contemplated that a plurality of legs may support each of the lower frames.

The plurality of legs may be connected to seating tracks disposed within a floor of an aircraft cabin.

Other aspects and features of the present invention will be made apparent from the discussion that follows, as should be understood by those skilled in the art.

### BRIEF DESCRIPTION OF THE DRAWINGS

The present invention will now be described in connection with the drawings appended hereto, in which:

FIG. 1 is a perspective, front view of a first embodiment of a convertible aircraft divan contemplated by the present invention, showing the divan in a first orientation (also referred to as a seating orientation), showing the divan in one possible placement location within the interior of an aircraft;

FIG. 2 is a side view of the divan illustrated in FIG. 1, also showing the divan in the seating orientation;

FIG. 3 is another perspective view of the divan shown in FIG. 1, illustrating the divan in a second orientation (also referred to as a bunk bed orientation) within the aircraft interior;

FIG. 4 is a side view of the divan shown in FIG. 3, showing the divan in the bunk bed orientation;

FIG. 5 is a perspective view of the divan shown in FIGS. 1-4, illustrating the supporting frame structure of the divan;

FIG. 6 is a perspective, rear view of the divan illustrated in FIG. 5, the divan being shown in the first orientation;

FIG. 7 is a perspective, front view of the divan shown in FIG. 5, the divan being illustrated in the second orientation;

FIG. 8 is a top, plan view of two of the divans illustrated in FIG. 1, shown in a side-by-side arrangement within the interior of an aircraft;

FIG. 9 is a perspective, front view of the divan illustrated in FIG. 1, showing one contemplated appearance of the divan having been dressed with an upholstered exterior;

FIG. 10 is a perspective, side view of a second embodiment of a divan according to the present invention, the divan being shown in the first (or seating) orientation;

FIG. 11 is a side view of the divan shown in FIG. 10;

FIG. 12 is front view of the divan illustrated in FIG. 10;

FIG. 13 is a rear view of the divan shown in FIG. 10;

FIG. 14 is a top view of the divan shown in FIG. 10;

FIG. 15 is a bottom view of the divan shown in FIG. 10;

FIG. 16 is a perspective illustration of a third embodiment of a divan according to the present invention, the divan being shown in the first (or seating) orientation;

FIG. 17 is a perspective illustration of the divan shown in FIG. 16, illustrating a drawer extending into the aisle of the aircraft from a storage locker beneath the divan;

FIG. 18 is a perspective view of the divan shown in FIG. 16, illustrating the divan in the second (or bunk bed) orientation;

FIG. 19 is a perspective illustration of a fourth embodiment of a divan according to the present invention, showing the divan in the second (or bunk bed) configuration;

FIG. 20 is a side view of the divan illustrated in FIG. 19, showing the divan in the first (or seating) configuration;

FIG. 21 is a side view of the divan shown in FIG. 19, the divan being shown in the second (or bunk bed configuration);

FIG. 22 is a perspective illustration of the divan shown in FIG. 19, the divan being illustrated in the first (or seating) configuration;

FIG. 23 is a side view of the divan illustrated in FIG. 19, showing one possible placement of the divan within an interior of an aircraft, the divan being illustrated in the first (or seating) configuration;

FIG. 24 is a side view of the divan illustrated in FIG. 19, showing one possible placement of the divan within an interior of an aircraft, the divan being illustrated in the second (or bunk bed) configuration; and

FIG. 25 is a three-part illustration showing a fifth embodiment of a divan according to the present invention.

### DETAILED DESCRIPTION OF EMBODIMENT(S) OF THE INVENTION

The present invention will now be described in connection with one or more contemplated embodiments. The embodiments that are described are intended to be exemplary of the present invention and not limiting of the scope thereof. In other words, while attention is focused on specific embodiments of the present invention, those embodiments are not intended to limit the present invention. To the contrary, the embodiments are intended to be exemplary of the breadth and scope of the present invention. Any discussion, therefore, of specific embodiments is not intended to be limiting of the present invention.

As noted above, the divan of the present invention is intended for installation on smaller diameter jet aircraft of the type commonly purchased by corporations and individuals. While it is contemplated that the present invention will be employed as furniture on these smaller diameter aircraft, the present invention is not intended to be limited solely to such an environment. It is envisioned that the divan of the present invention may be employed on any size aircraft.

In the alternative, it is contemplated that the divan of the present invention may be employed in other types of vehicles including, but not limited to, boats, vans, trains, trucks, recreational vehicles, etc. Accordingly, the divan of the present invention should not be understood as being limited for use in only one potential environment.

With respect to the embodiments described herein, specific materials are discussed for the various elements of the divan of the present invention. Any discussion of a particular material is intended to be exemplary of the types of materials that may be employed and is not intended to be limiting of the present invention. Other materials may be used for the construction of the divan of the present invention without departing from the scope of the present invention.

In addition, it is noted that several embodiments of the divan of the present invention are mechanically operated. In other words, several of the disclosed embodiments are intended to be manipulated manually between the first and second orientations (e.g., between the seating and bunk bed orientations). A manually manipulated divan offers an advantage in that the divan is light in weight, because it does not incorporate electrical motors and/or pneumatic equipment to assist with transitioning the divan between the seating orientation and the bunk bed orientation. While a mechanical operation offers a light weight construction, which is beneficial for aircraft where any additional weight potentially reduces the flight range for the aircraft, electrical, pneumatic, electro-mechanical, and other devices may be incorporated into the divan without departing from the scope of the present invention.

As should be apparent to those skilled in the art, the flight range (or “range”) of an aircraft is a function of the distance that an aircraft may fly, when fully loaded, as measured from a point of origin. The range of an aircraft is dependent upon a number of variables that include, but is not limited to, the weight of the aircraft, its fuel capacity, and its maximum allowable take-off weight. As the weight of the aircraft increases, the range of the aircraft decreases. Since the take-off weight of an aircraft places an upper limit on the aircraft, there is a limited amount of fuel that the aircraft may take on and remain witin its take-off limit It is also noted aircraft also have a maximum zero fuel weight limit Therefore, any added weight (in the form of furniture) adversely affects the payload capacity of that aircraft.

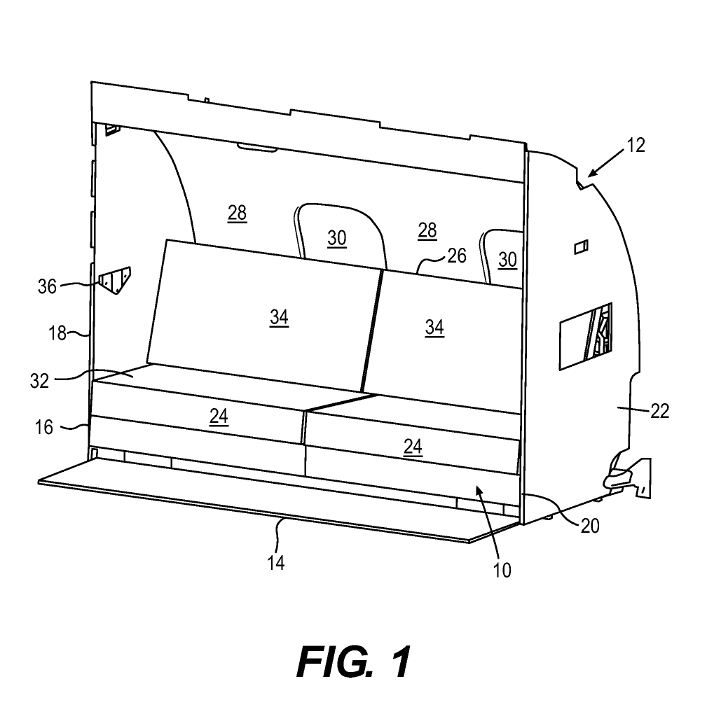

FIG. 1 is a perspective illustration of a first embodiment of the divan 10 of the present invention. The divan 10 is shown in the interior of an aircraft 12 at a position on the starboard side (or right hand side) thereof. It is contemplated that the divan 10 might be positioned at a location opposite to an entry door (not shown) into the aircraft 12. While this particular position is contemplated for the divan 10 of the present invention, the divan may be placed at any location within the aircraft 12, as should be apparent to those skilled in the art. Moreover, while the divan 10 is shown in a position against an exterior wall (i.e., parallel to a longitudinal axis of the sidewall) of the aircraft 12, the divan 10 may be placed in any orientation with respect to the longitudinal axis of the aircraft 12 without departing from the scope of the present invention.

To facilitate an understanding of the present invention, aspects of the aircraft 12 are illustrated in selected figures of the drawings. In FIG. 1, for example, the aircraft 12 is illustrated with a deck or floor 14 to which the divan 10 is secured in a conventional manner. The front end 16 of the divan 10 is bounded by a front bulkhead wall 18. The rear end 20 of the divan 10 is bounded by a rear bulkhead wall 22. The front side 24 of the divan is visible above the floor 14. The rear side 26 of the divan abuts against the sidewall 28 of the aircraft 12. For reference, two windows 30 are visible in the sidewall 28 of the aircraft 12.

In FIG. 1, the divan 10 is shown in a first orientation, which is also referred to as the seating orientation for purposes of the instant discussion. In the seating orientation, the divan 10 presents a seating surface or seat 32 and a backrest 34.

For purposes of the description of the present invention, the term “seating configuration” also is used. The terms “seating configuration” and “seating orientation” are intended to have the same meaning. Similarly, the term “bunk bed configuration” and “bunk bed orientation” are used interchangeably.

With renewed reference to FIG. 1, one of two brackets 36 is visible. The bracket 36 that is visible is attached to the front (or forward) bulkhead wall 18. A second bracket 36 (not visible in this illustration) is attached to the rear bulkhead wall 22. The brackets 36 are provided to support the top bunk when the divan 10 is in the second configuration.

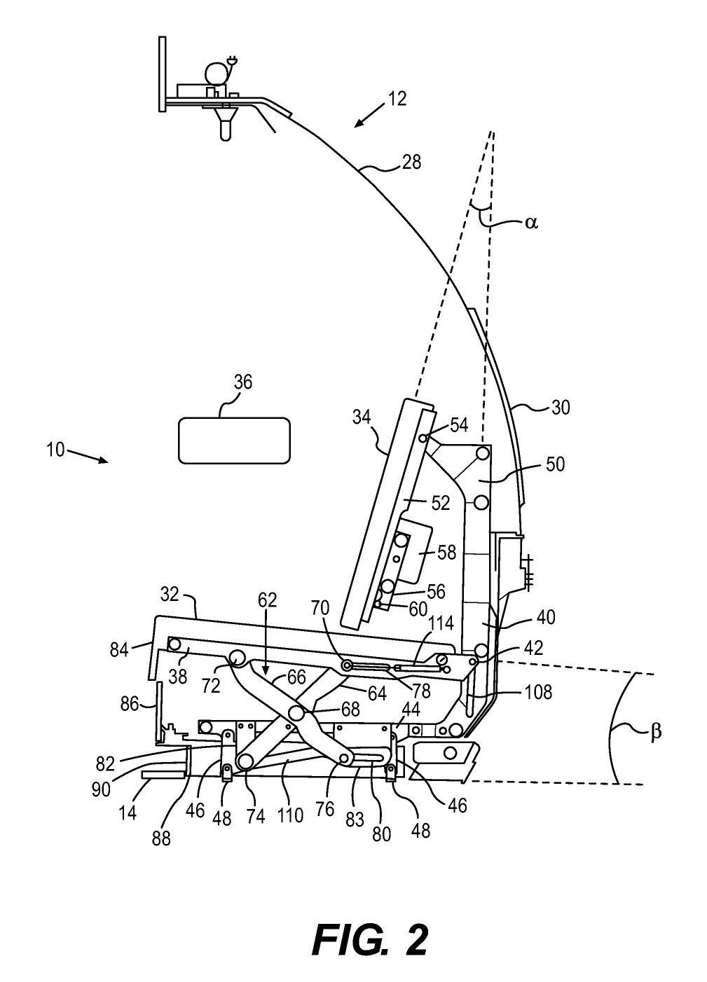

FIG. 2 is a side view of the divan 10 illustrated in FIG. 1. The view is of the rear end 20 of the divan 10. As such, the view is from the perspective of an observer standing at an aft position of the aircraft 12 looking toward the front of the aircraft 12.

In FIG. 2, the divan 10 is illustrated in the first orientation, or the seating orientation. In this illustration, the sidewall 28, one of the windows 30, and the bracket 36 on the front bulkhead wall 18 are visible.

The divan 10 includes a seating surface 32 and a backrest 34. The seating surface 32 is supported on a seat frame element 38, which is pivotally and slidably mounted to a vertical support frame element 40 at a seat pivot point 42.

The vertical frame element 40 extends from a lower frame element 44 that runs parallel to the floor 14. The lower frame element 44 is supported by legs 46. The legs 46 are affixed to track elements 48 that are positioned in the floor 14 and extend along the longitudinal length of the aircraft 12. The connection between the legs 46 and the tracks 48 is conventional, as should be apparent to those skilled in the art.

With respect to the tracks 48, those skilled in the art will readily appreciate that the interior of an aircraft includes a plurality of tracks 48 embedded within the floor 14 of the aircraft's cabin. Various pieces of furniture, including passenger seats, are attached to the tracks 48. The tracks are constructed so that elements may be affixed thereto at any selected (or predetermined) location along their lengths.

Since the divan 10 connects to the floor 14 via the tracks 48, it is not contemplated that the divan 10 will connect to any other part of the aircraft 12, such as the sidewall 28. As noted, connection to the tracks 48 is a standard connection, as should be apparent to those skilled in the art.

The top end 50 of the vertical frame element 40 connects pivotally to a backrest frame element 52 at a backrest pivot point 54. This connection permits the backrest 34 to be adjusted to any suitable angle, although a limited number of angular positions are contemplated to be employed in operation of the divan 10. This also permits the backrest 34 to pivot upwardly, or toward the front of the divan 10, so that it may be transitioned to the second orientation where the backrest 34 forms the upper bunk, as discussed in greater detail below.

An extension frame element 56, which supports an extension surface 58, is pivotally connected to the backrest frame element 52 at extension pivot point 60. When extended, the extension surface 58 increases the width of the backrest 34 to create a more suitable bed surface for an occupant.

As should be apparent from the various figures appended hereto, the seat frame element 38 is illustrative of several seat frame elements 38 that may be positioned beneath the seating surface 32 of the divan 10, between the front end 16 and the rear end 20, to support the seating surface 32. It is contemplated that there will be at least two seat frame elements 38, one at either end of the seating surface 32, to provide structural support for the seating surface 32. Other frame elements that make up the divan 10 also are anticipated to be incorporated into the divan 10 in multiples. Moreover, while any particular figure may illustrate one or more frame elements, a larger or fewer number of similar frame elements may be employed without departing from the scope of the present invention.

With continued reference to FIG. 2, the backrest 34 of the divan 10 is contemplated to be disposed at a backrest angle α with respect to a vertical line that is perpendicular to the surface of the floor 14. Similarly, the seating surface 32 is contemplated to be disposed at an angle β with respect to the surface of the floor 14. For comfort, it is contemplated that the backrest 34 will be disposed at a positive angle. In other words, it is anticipated that the backrest 34 will not be parallel to a vertical line passing perpendicularly through the floor 14. In addition, it is contemplated that the seating surface 32 will be angled such that the portion adjacent to the backrest 34 will be at a height lower than the front of the seating surface 32. As such, the seating surface 32 will not be disposed in a position parallel to a plane defined by the floor 14. While the angles α, β are contemplated as being greater than 0°, one or both of the angles α, β may be 0° without departing from the scope of the present invention.

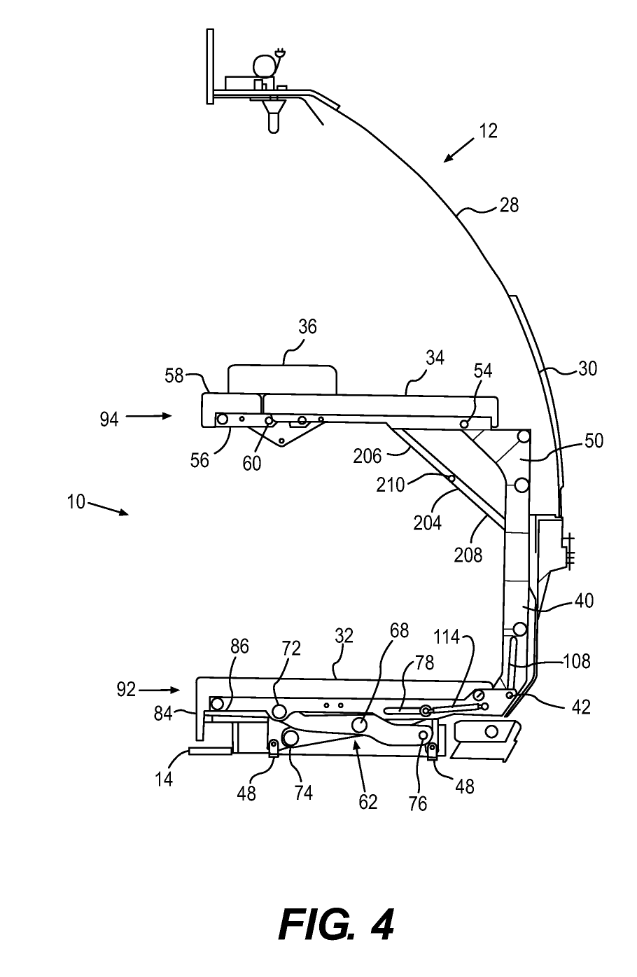

FIG. 2 also illustrates a scissor support 62 that includes a first scissor element 64 and a second scissor element 66. The scissor support 62 connects the seat frame element 38 to the lower frame element 44 such that the seating surface 32 may be lowered from a seating height (shown) to a sleeping height (discussed below and illustrated in FIG. 4).

As is shown in FIG. 2, the first and second scissor elements 64, 66 pivotally connect to one another at a scissor pivot 68, which is roughly centered on each of the individual scissor elements 64, 66. The first and second scissor elements 64, 66 connect to the seat frame element 38 at first and second upper pivot points 70, 72. The first and second scissor elements 64, 66 connect to the lower frame element 44 via first and second lower pivot points 74, 76.

The first upper pivot point 72 is positioned at a fixed location on the seat frame element 38. So that the scissor support 62 may collapse to permit lowering of the seating surface 32, the second upper pivot point 70 is pivotally and slidably positioned within an upper slot 78 within (or connected to) the upper seat frame element 38. Similarly, the lower pivot point 74 at the bottom of the first scissor element 64 is connected pivotally at a fixed location on (or near) the lower frame element 44. The lower pivot point 76 of the second scissor element 66 is pivotally and slidably disposed within a lower slot 80, permitting a sliding engagement with respect to the lower frame element 44.

Alternative contemplated embodiments are anticipated to include slots 78, 80 in locations other than those illustrated and described herein. In other words, the locations of the slots 78, 80 is not intended to be limiting of the present invention.

As should be apparent from FIG. 2, the lower pivot point 74 is positioned on a first positioning plate 82 extending downwardly from the lower frame element 44 to a point above the floor 14. A second positioning plate 83 includes the lower slot 80. The second positioning plate 83 also extends beneath the lower frame element 44. The two positioning plates 82, 83 permit the seating surface 32 to be lowered to as low a point as contemplated for the divan 10 of the present invention. As should be apparent, the positioning plates 82, 83 may be excluded from the divan 10 of the present invention without departing from the scope thereof.

FIG. 2 also illustrates a drop down 84 and a front wall 86. The drop down 84 is a wall that extends downwardly from the front side 24 of the seating surface 32. The drop down 84 is anticipated to rest against (or adjacent to) the floor 14 when the divan 10 is in the bunk bed configuration. The front wall 86 extends upwardly from a position in from of the lower frame element 44. In this embodiment, the front wall 86 connects to a point above a storage locker 88 under the divan 10. The storage locker 88 is provided for stowage of components such as life vests, etc. The storage locker 88 may be provided with a door 90 to conceal the contents therein.

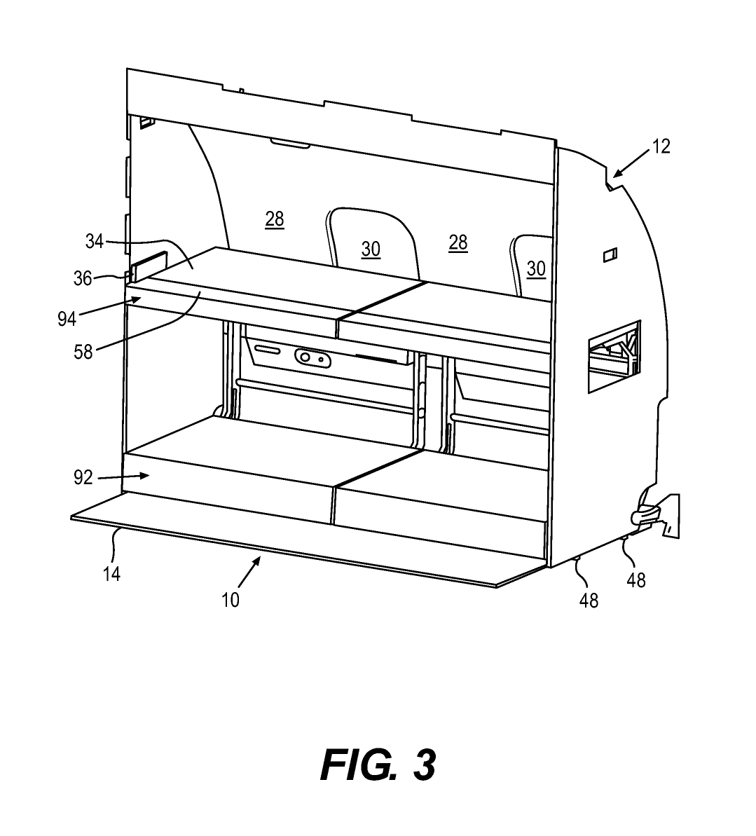

FIG. 3 is a perspective illustration of the divan 10 of the present invention, shown in the second orientation or bunk bed orientation. Here, the seating surface 32 has been lowered and is positioned essentially parallel to the floor 14. In this orientation, the seating surface 32 forms the lower bunk 92. The upper bunk 94, which is a combination of the backrest 34 and the extension surface 58, also is essentially parallel to the floor 14.

FIG. 4 is a side view of the divan 10 in the bunk bed orientation. The positioning of the lower bunk 92 and the upper bunk 94 in positions substantially parallel to the floor 14 is apparent from this illustration. The scissor support 62 is illustrated in the collapsed position.

In the bunk bed orientation, the front wall 86 has been collapsed into a horizontal position beneath the lower bunk 92. As such, it is contemplated that the front wall 86 will be connected to the divan 10 such that the front wall 86 may be manually manipulated to collapse when the divan 10 is transitioned from the seating configuration to the bunk bed configuration. As such, the front wall 86 may be constructed as a hinged panel that pivots and then slides under the seating surface 32 for stowage. The seating surface 32 is lowered after the front wall 86 is properly stowed. The front wall 86 may be returned manually to a vertical position when the divan 10 is returned to the seating configuration.

In an alternate construction, the front wall 86 may be designed so that it automatically collapses when the divan 10 is transitioned from the seating configuration to the bunk bed configuration. A spring may be provided for this function. When the divan 10 is transitioned from the bunk bed configuration back to the seating configuration, it is contemplated that the front wall 86 will return to its vertical orientation via a suitable biasing mechanism.

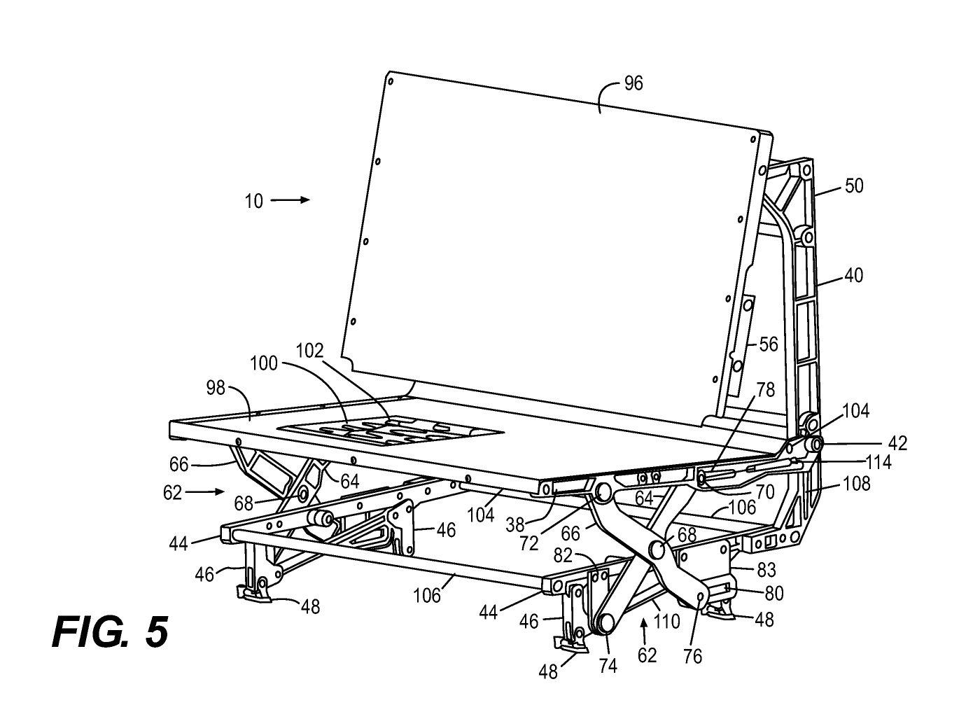

FIG. 5 is another perspective illustration of the divan 10 of the present invention. To clarify the construction of the divan 10, the upholstery has been removed from the frame of the divan 10. As such, the construction of the backrest frame 96 and the seating frame 98 are more readily discernable.

The backrest frame 96 is contemplated to be constructed as a single sheet of material, such as aluminum. As should be apparent to those skilled in the art, the backrest frame 96 may be made of any alternative material, including plastics or composite materials, without departing from the scope of the present invention.

Similarly, the seating frame 98 is contemplated to be constructed as a single sheet of material, such as aluminum. As with the backrest frame 96, alternative materials may be used without departing from the scope of the present invention.

With respect to the seating frame 98, an opening 100 is provided therein. The opening 100 is traversed by a plurality of springs 102 that are designed to support the seating surface 32 and provide a more flexible seating surface for the occupant. Specifically, the springs 102 are positioned such that they flex when a person is sitting on the divan 10, thereby providing a more comfortable seating surface 32. While it is contemplated that the springs 102 will be made from a material such as steel, other materials may be used without departing from the scope of the present invention.

FIG. 5 illustrates the placement of the opening 100 at one side of the seating frame 98. The placement of the opening 100 at this location is provided merely to illustrate one potential location for the opening 100. In an alternate construction, it is contemplated that at least two openings 100 will be provided, one at each end of the seating frame 98. In a further alternative embodiment, the opening 100 is contemplated to extend from one side of the seating frame 98 to the other. As should be apparent to those skilled in the art, still further arrangements for the openings 100 are possible without departing from the scope of the present invention.

With respect to the springs 102, it is contemplated that S-coil springs will be employed. Other types of springs 102 may be substituted for the S-coil springs without departing from the scope of the present invention.

With continued reference to FIG. 5, it is noted that the divan 10 includes two seat frame elements 38 that are connected to one another by two seat frame connectors 104. As is apparent from this illustration, the frame elements 38, 104 form a rectangular structure that supports the seating frame 98.

The divan 10 also includes two lower frame elements 44 that are connected to one another via two lower frame connectors 106. The lower frame elements 44 and connectors 106 form a rectangular structure. The lower frame elements 44 and connectors 106 are connected to the seating frame elements 38 and seating frame connectors 104 via the two scissor supports 62, among other structures.

As discussed above, the first upper pivot point 70 of each of the first scissor elements 64 is disposed within an upper slot 78. The second positioning plate 83 includes a lower slot 80 in which the second lower pivot point 76 slides. The vertical frame 40 includes a slot 108. The seat pivot 42 slides in the slot 108. Together these slots 78, 80, 108 cooperate with the associated frame elements to permit the divan 10 to be reconfigured from the seating orientation to the bunk bed orientation.

FIG. 5 also depicts leg connectors 110. The leg connectors 110 extend between the legs 46 to provide increased structural rigidity to the divan 10.

In connection with FIG. 5, it is noted that the various frame elements, such as the vertical frame element 40, are constructed to have as low a weight as practicable. As such, there are numerous hollowed out regions on the structural elements (including the vertical frame element 40). While this type of construction is preferred, it is possible that other constructions may be employed without departing from the scope of the present invention.

The various frame elements that comprise the divan 10 are contemplated to be made from a material such as aluminum. While aluminum is contemplated due to its strength and low weight, other materials may be employed without departing from the scope of the present invention. For example, the frame elements may be made from a composite material, a natural material, plastics, other metals, and metal alloys.

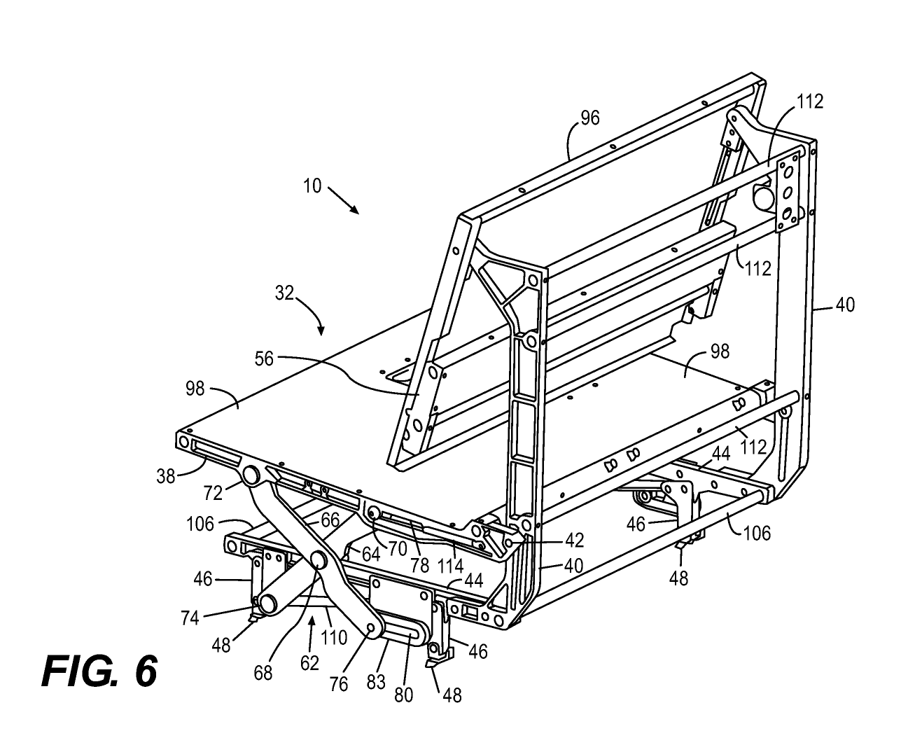

FIG. 6 is a perspective illustration of the divan 10 of the present invention, this view being taken from the rear of the divan 10. Here, the extension frame element 56 is more clearly visible. In addition, three frame connectors 112 are shown. The frame connectors 112 provide structural support to the frame of the divan 10 by connecting the vertical frame elements 40 to one another.

With respect to FIGS. 2, 4, 5, and 6, it is noted that a damper 114 connects between the rear end of the seat frame element 38 and the first upper pivot point 70 at each side of the divan 10. The term “damper” is intended to refer to a wide variety of devices such as gas springs, springs, or other mechanisms that provide an assist for transitions of the divan 10 beterrn the seating configuration and the bunk bed configuration. While the dampers 114 are not required to practice the present invention, they are provided to control the movement of the seating surface 32 between the seating configuration and the bunk bed configuration. Specifically, the dampers 114 permit for a gradual transition of the seating surface 32 from the seating orientation to the bunk bed orientation without a sudden drop, as would be expected in the absence of the dampers 114.

As should be apparent to those skilled in art, other elements may be employed instead of the dampers 114 to facilitate movement of the seating surface 32 from the seating configuration to the bunk bed configuration. For example, the damper 114 may be replaced by an elastic member, such as a spring. Variations on the damper 114, therefore, are contemplated to fall within the scope of the present invention.

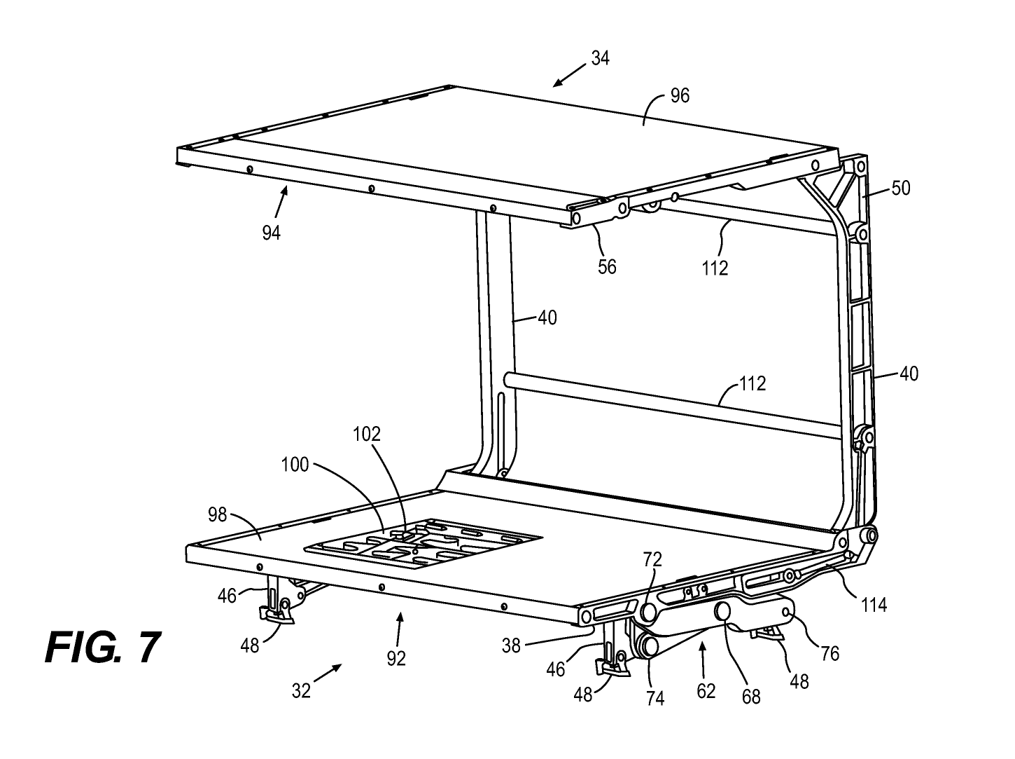

FIG. 7 is a perspective illustration of the divan 10 of the present invention, where the seating surface 32 and the backrest 34 are shown in the bunk bed (or second) orientation.

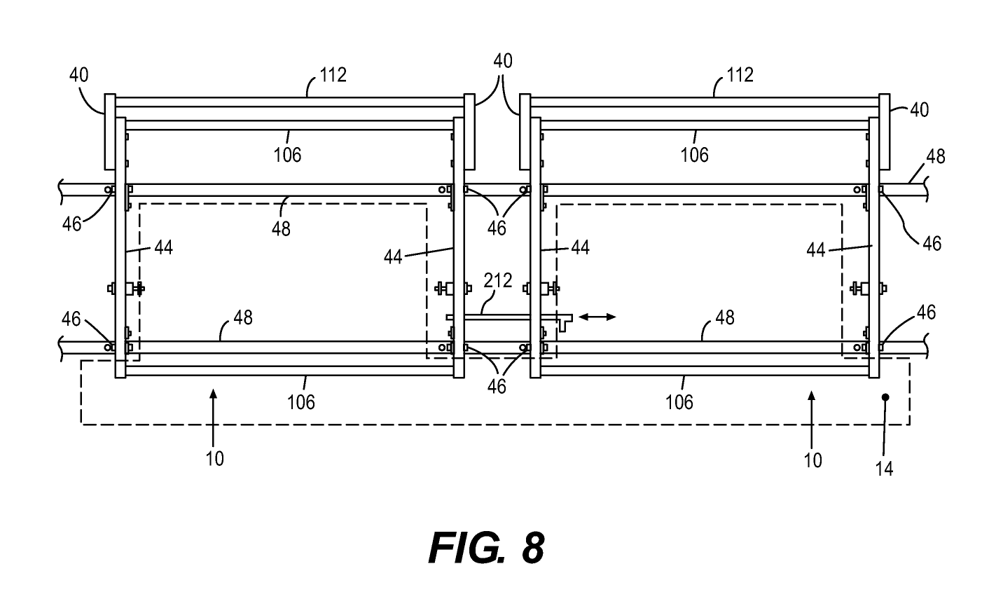

FIG. 8 is a top view of the divan 10 of the present invention, illustrating a further, contemplated aspect of the present invention. Specifically, it is contemplated that the divan 10 of the present invention will be positioned within an aircraft together with a duplicate of the same divan 10 in a side-by-side arrangement. Among other reasons, the placement of two divans 10 adjacent to one another provides for a construction which is easier to transition from the seated orientation to the bunk bed orientation, because the user need only manipulate one half of the weight that would be required to be manipulated if the divan 10 were a singular construction and not made from two side-by-side divans 10.

Other variables and factors also motivate the placement of two divans 10 adjacent to one another. It is known that compliance with regulatory guidelines (such as those by the United States Federal Aviation Administration “FAA”) may be facilitated by including two shorter divans 10 adjacent to one another rather than employing a single, long divan 10 in an aircraft 12 (at least in certain orientations). For example, smaller divans 10, when connected to the tracks 48, are believed to be better suited to react to the types of dynamic loads that are experienced during take-off and landing.

Additionally, due to the weight of each of the individual divans 10, it is contemplated that the additional attachment points of the divans 10 to the tracks will provide an improved connection of the divan 10 to the floor 14 of the aircraft 12, because there are a greater number of attachment points to distribute interface loads between the divans 10 and the seat tracks 48. Still further advantages of this construction should be apparent to those skilled in the art.

FIG. 8 illustrates the positions of the tracks 48, within the floor 14, beneath the divans 10. As noted, the legs 46 of the divans 10 are connected to the tracks 48 in a conventional manner, as should be understood by those skilled in the art.

As noted above, it is contemplated that the divan 10 may be installed in combination with other divans 10 to form a single seating area within the aircraft 12. In other words, the divan 10 of the present invention may be a single divan unit 10 or a combination of multiple divan units 10 arranged side-by-side. Both arrangements are intended to be encompassed by the present invention.

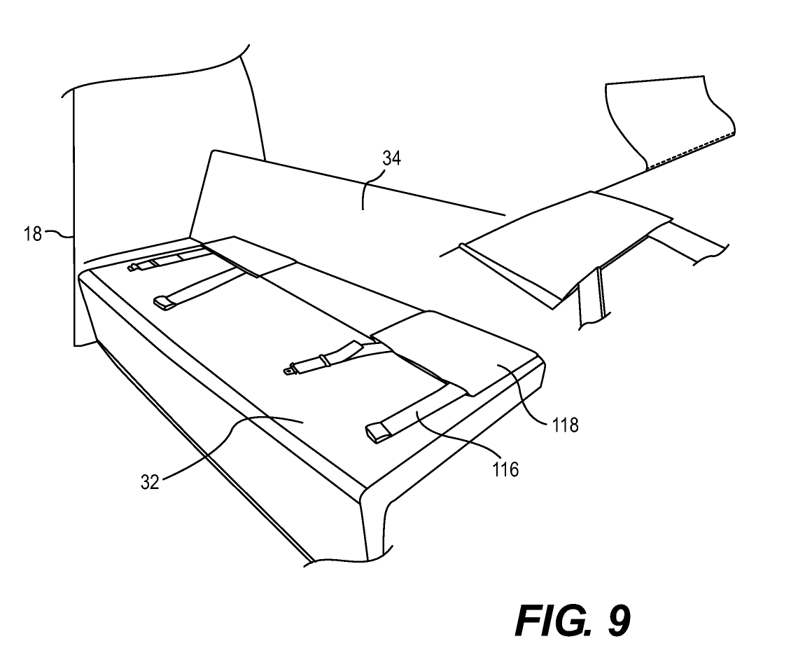

FIG. 9 is a perspective illustration that presents the appearance contemplated for the divan 10 of the present invention after application of upholstery to the divan 10. As illustrated, the divan 10 will be provided with one or more restraint belts 116 (or seat belts). The restraint belts 116 may be provided with a belt guide or sleeve 118, which is anticipated to be used to secure a person on the seating surface 32 when the divan 10 is in the bunk bed orientation. Since the sleeves 118 are anticipated to be used only when the divan 10 is in the seat configuration, the sleeves 118 may be hidden when the divan 10 is in the bunk bed configuration.

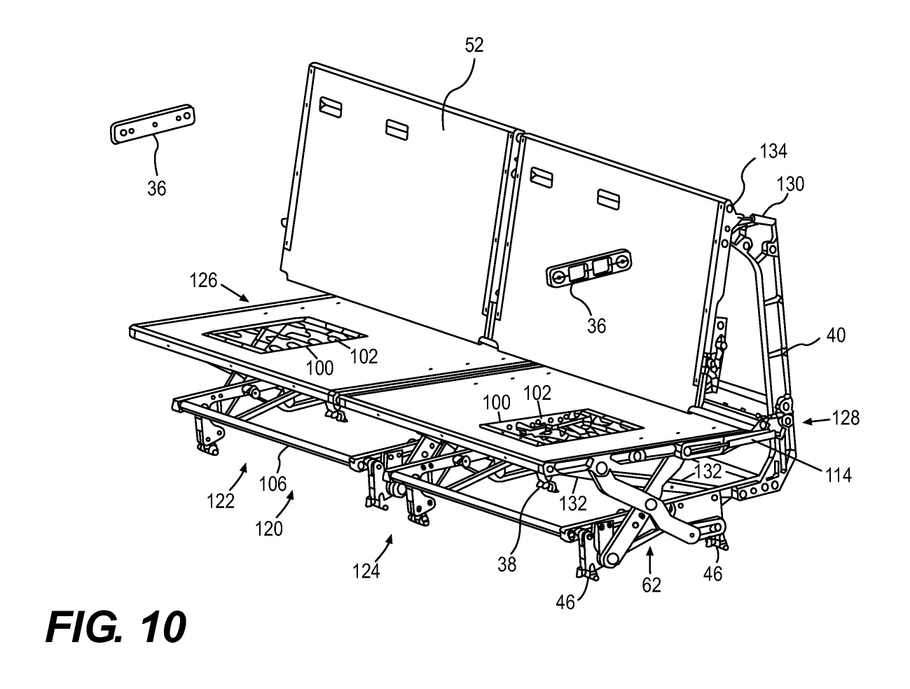

FIG. 10 is a perspective view of second embodiment of the present invention. In this embodiment, the divan 120 consists of two separate divan units 122, 124 that are positioned side-by-side. The divan units 122, 124 have essentially the same construction as the divan 10, with the following enumerated changes. Since the divan 120 is very similar to the divan 10 discussed above, the same reference numbers are employed to refer to structural components that the divan 120 shares with the divan 10.

In this embodiment, it is noted that the divan units 122, 124 are minor images of one another. As such, the openings 100 and the springs 102 are positioned at respective ends 126, 128 of the divan 120. It is anticipated that, when two persons sit on the divan 120, they will position themselves at respective ends 126, 128 of the divan 120. As a result, the openings 100 and springs 102 are provided at respective ends of the divan 120 to accommodate this passenger seating arrangement.

With respect to the divan 120, a damper 130 is provided between the top end 50 of the vertical frame element 40 and the top end 134 of the backrest frame element 52. The damper 130 provides weight-responsive control of the angular position of the backrest frame element 52. As such, when a person sits on the divan 120, the person's weight will press against the backrest 34, thereby applying a force to the damper 130. The damper 130 is constructed to provide a suitable resistive force. In addition, the damper 130 is employed to control the downward motion of the backrest frame element 52 when the divan 120 is transitioned from the bunk bed orientation to the seating orientation.

As noted above, the damper 130 may be a gas spring or other suitable alternative. In one embodiment of the present invention, it is contemplated that the backrest 34 will be locked into a particular position and that the damper 130 (or gas spring) will be provided primarily to assist with the transition of the divan 10 from the seating position to the bunk bed position.

As with the damper 114, it is contemplated that the damper 130 may be replaced with any suitable alternative component, such as a spring or other resilient member. Use of a suitable alternative is contemplated to fall within the scope of the present invention.

FIG. 10 also illustrates a cross-divan connector 132 that extends between the legs 46 of the divan units 122, 124 in a longitudinal direction of the aircraft 12. The cross-divan connector 132 provides structural stability to the divan units 122, 124 in the same manner as the connector 110.

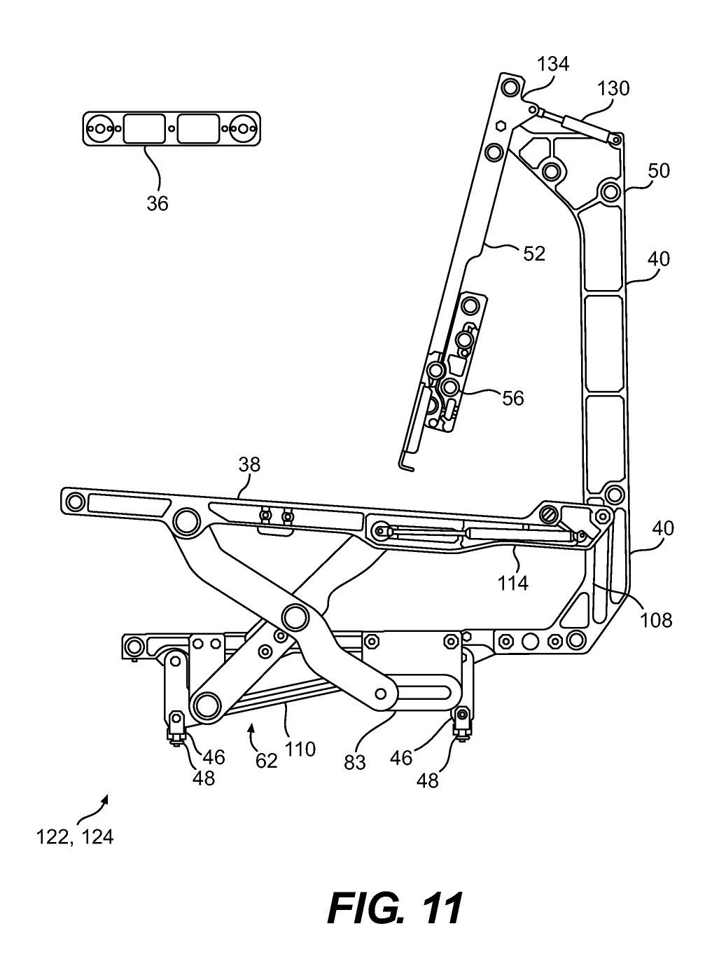

FIG. 11 is a side view of the divan 120 illustrated in FIG. 10. The positional relationship between the components of the divan 120 is apparent in this drawing. The damper 130 is clearly illustrated in this view.

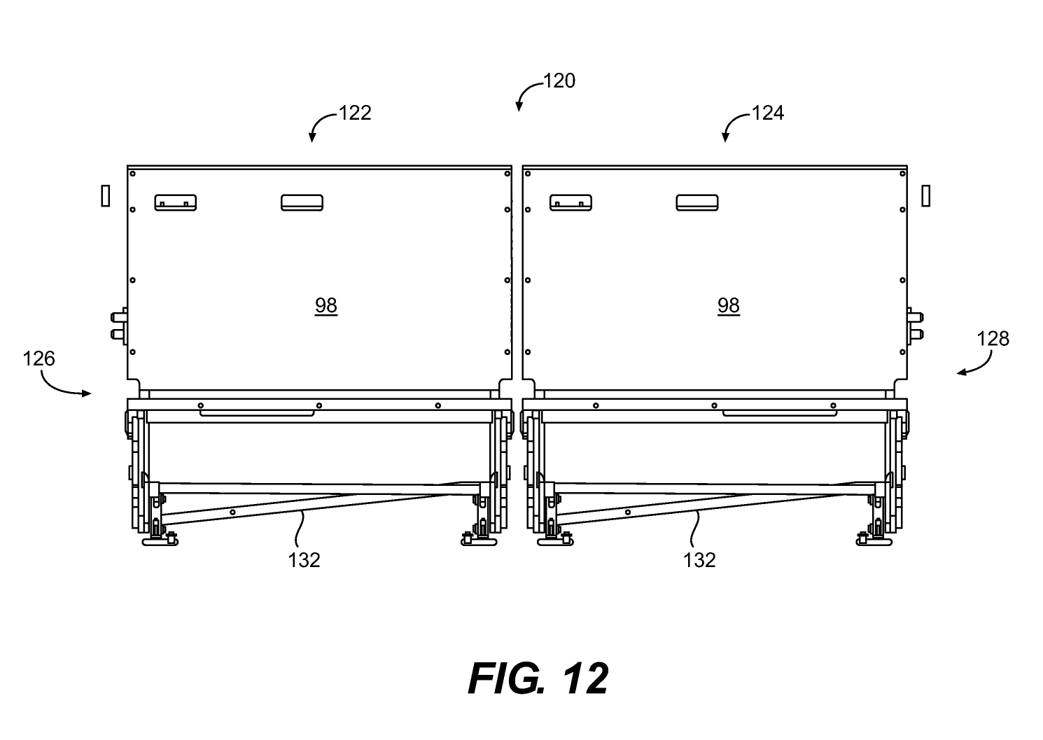

FIG. 12 is a front view of the divan 120 of the present invention. The cross-divan connector 132 is clearly visible in this illustration.

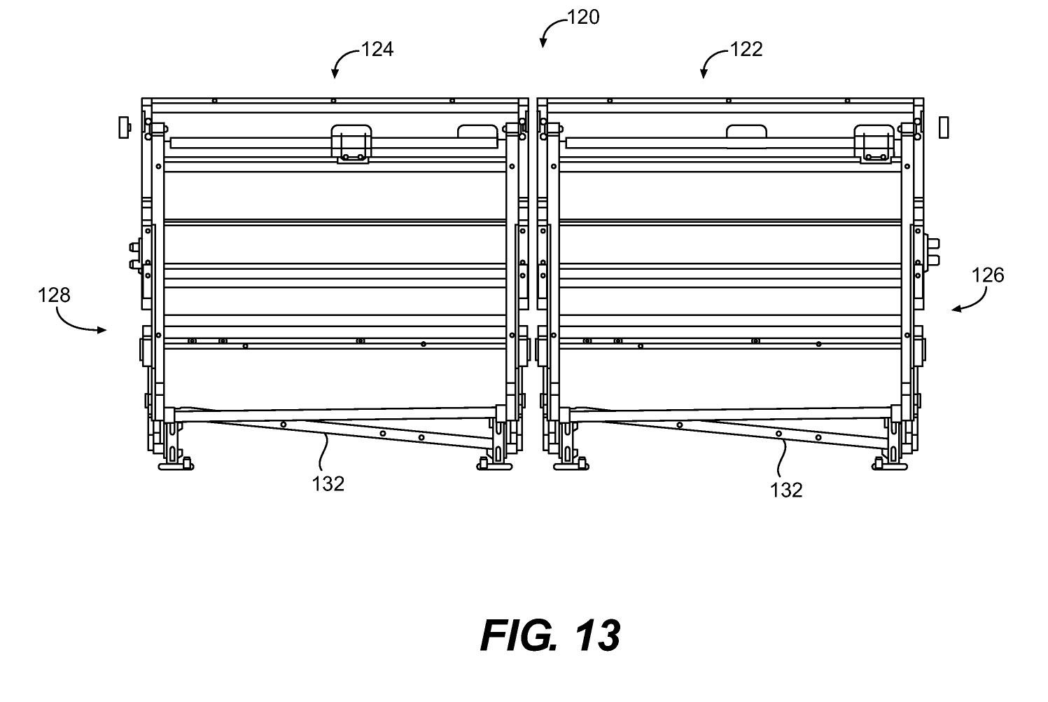

FIG. 13 is a rear view of the divan of the present invention, which is provided to illustrate the various positional relationships between the elements that comprise the divan 120.

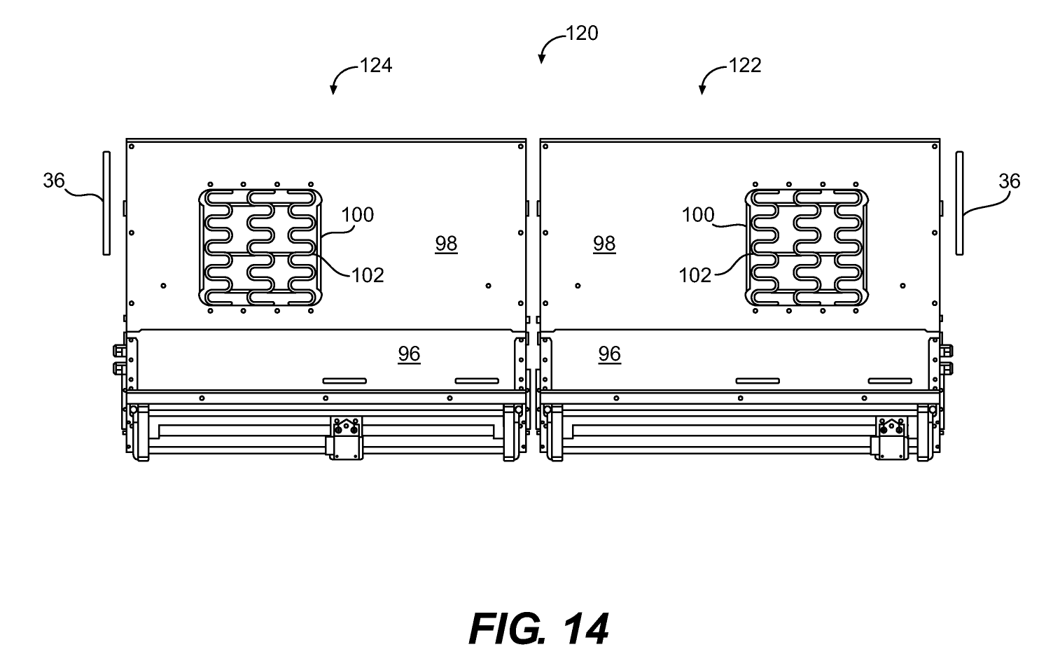

FIG. 14 is a top view of the divan 120 of the present invention.

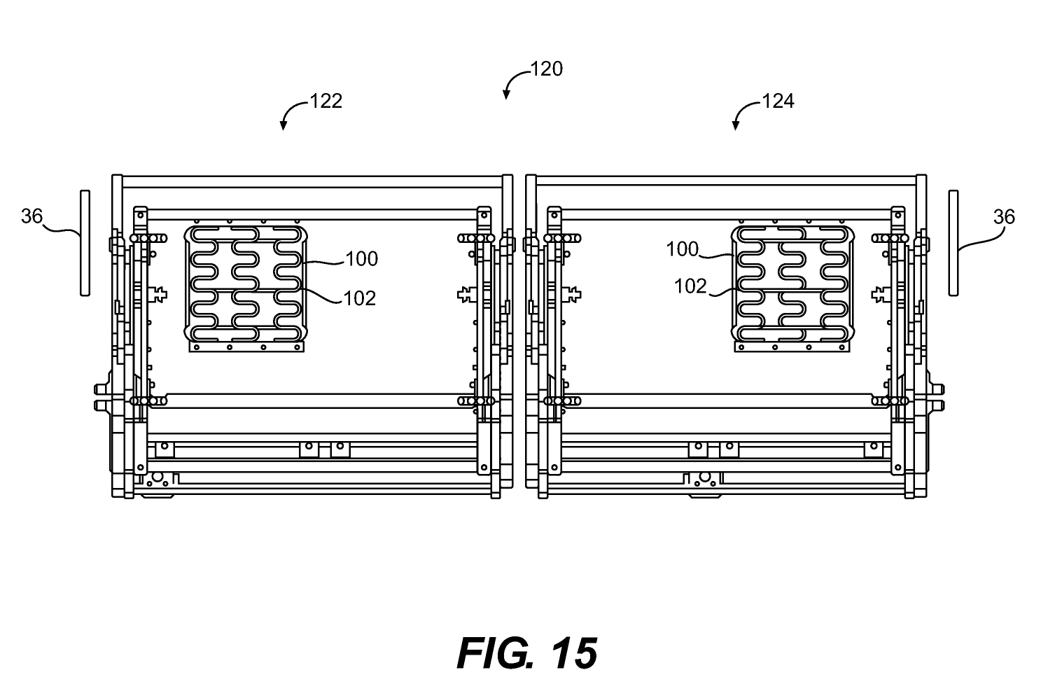

FIG. 15 is a bottom view of the divan 120 of the present invention.

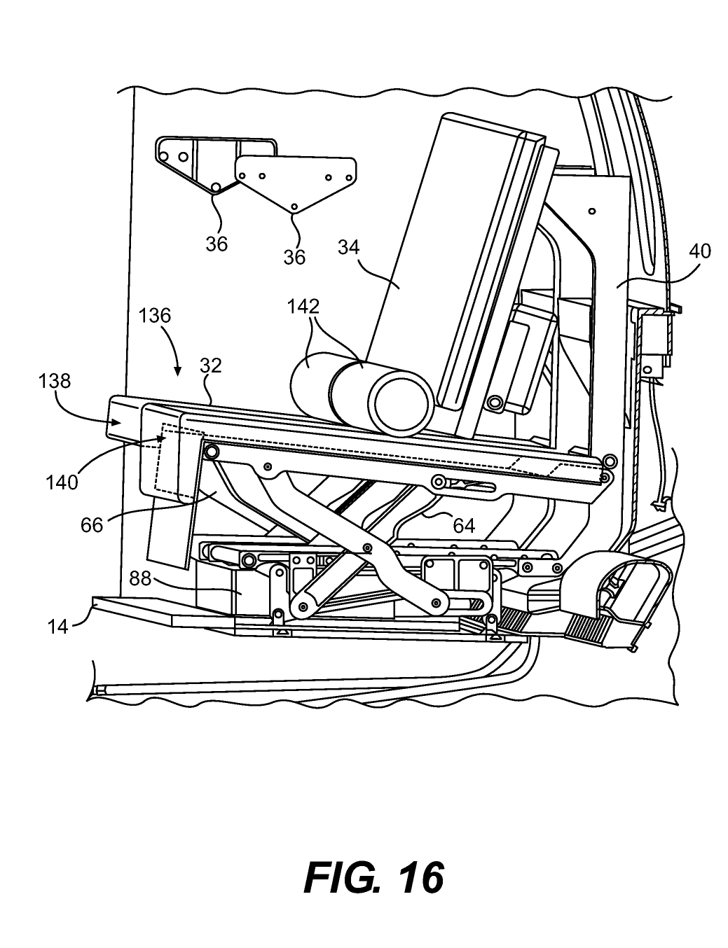

FIG. 16 is a perspective illustration of a third embodiment of a divan 136 according to the present invention. In this embodiment, the divan 136 includes two divan units 138, 140. This construction is similar to the construction for the divan 120 in the second embodiment of the present invention. As with the divan 120, the divan 136 shares numerous elements in common with the divan 10, 120. Accordingly, the same reference numerals are employed for those elements that the divan 136 has in common with the divan 10, 120.

The divan 136 differs from the divans 10, 120 in that this embodiment incorporates a bolster pillow 142 for each of the divan units 138, 140. The bolster pillow 142 serves as a transition between the seating surface 32 and the backrest 34 when the divan 136 is in the seating orientation. Specifically, the bolster pillow 142 may provide lumbar support for an occupant of the divan 136.

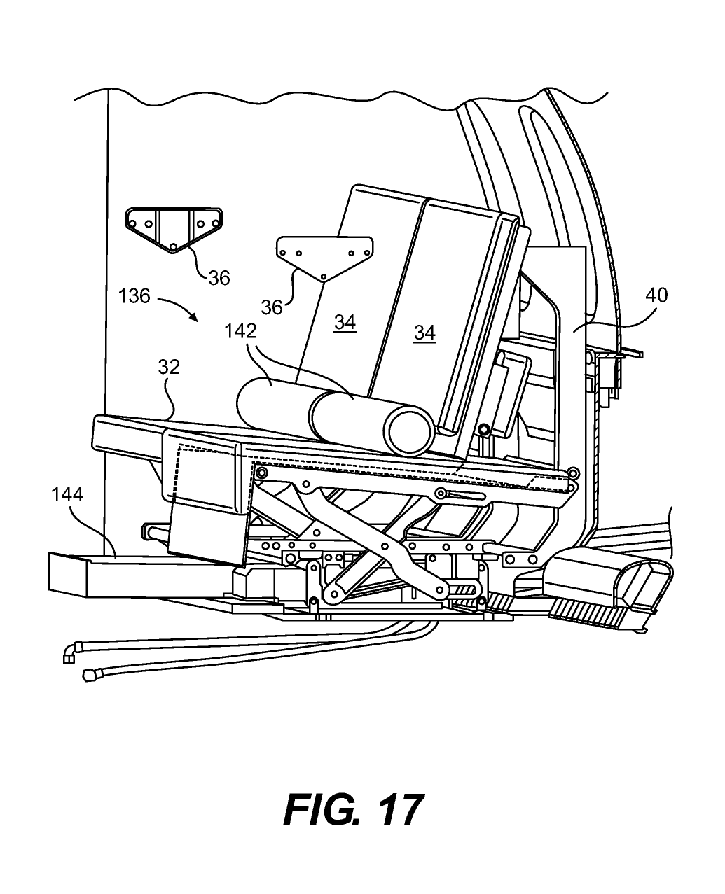

FIG. 17 is another perspective illustration of the divan 136. In this illustration, the storage locker 88 is shown in the opened position, with a drawer 144 extending outwardly therefrom. The drawer 144 is considered to be an optional feature. When included, the drawer 144 is anticipated to facilitate access to the contents in the storage locker 88, such as a life vest.

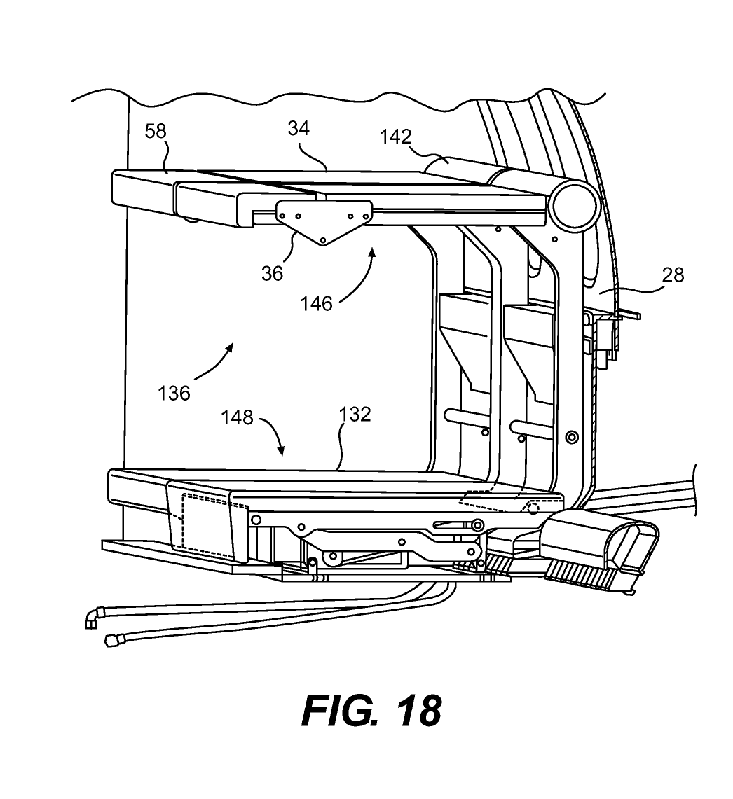

FIG. 18 is a perspective illustration of the divan 136 of the present invention, shown in the bunk bed orientation. As illustrated, the divan 136 has been converted into an upper bunk bed 146 and a lower bunk bed 148. In this orientation, the bolster pillow 142 serves as an extension of the upper bunk 146 by filling a gap between the upper bunk 146 and the sidewall 28 of the aircraft 12.

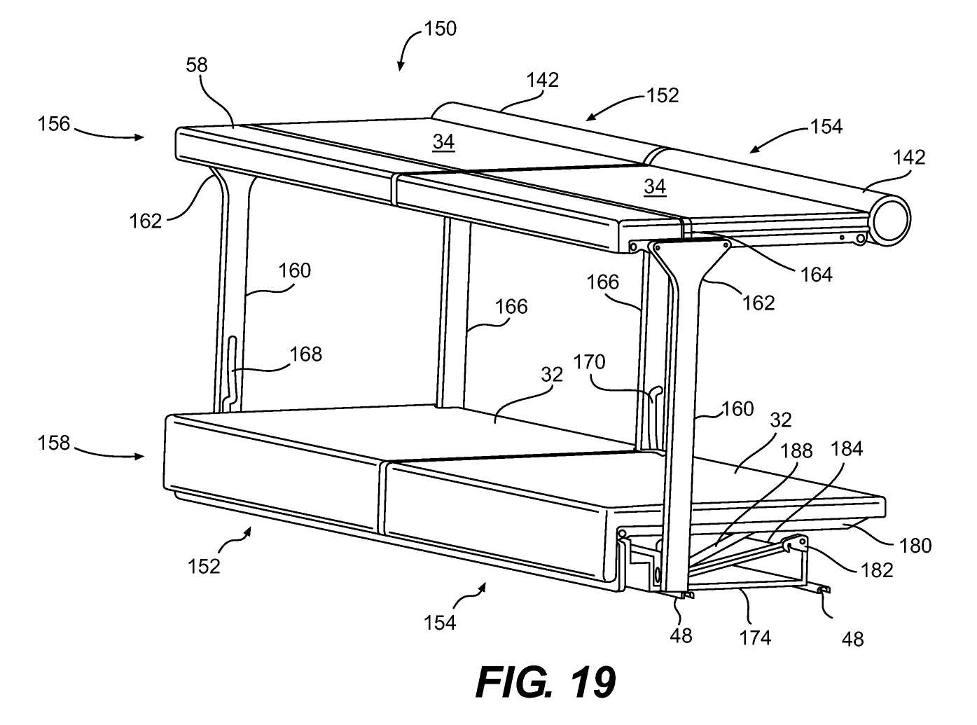

FIG. 19 is a perspective illustration of a fourth embodiment of a divan 150 according to the present invention. This embodiment is a variation of the third embodiment of the divan 136, described above. Like prior embodiments, the divan 150 combines two divan units 152, 154 in a side-by-side arrangement to establish a long, couch-like furniture element for the aircraft 12. The divan 150 is illustrated in the bunk bed orientation in this figure. As a result, the divan 150 defines an upper bunk 156 and a lower bunk 158.

In this embodiment, the brackets 36 have been replaced by uprights 160. The uprights 160 connect to the legs 46 and/or the lower frame element 44 of the divan 150. The uprights 160 incorporate brackets 162 at the top ends 164 thereof. The support brackets 162 support the upper bunk 156 when the divan 150 is in the bunk bed configuration.

This fourth embodiment of the divan 150 of the present invention excludes the scissor 62 that is included in prior embodiments. To secure the seating element 32 in the proper orientation, the uprights 160 and the vertical frame elements 166 (at the rear of the divan 150) include serpentine slots 168, 170, respectively. The serpentine slots 168, 170 are shaped so that the seating surface 32 may be moved from the seating position to the bunk bed position. As should be understood by those skilled in the art, protrusions on the seat frame element 172 engage the serpentine slots 168, 170. Manipulation of the seating surface 32, therefore, permits a person to transition the seating element 32 from a seating orientation (a first orientation) to a bunk bed orientation (a second orientation).

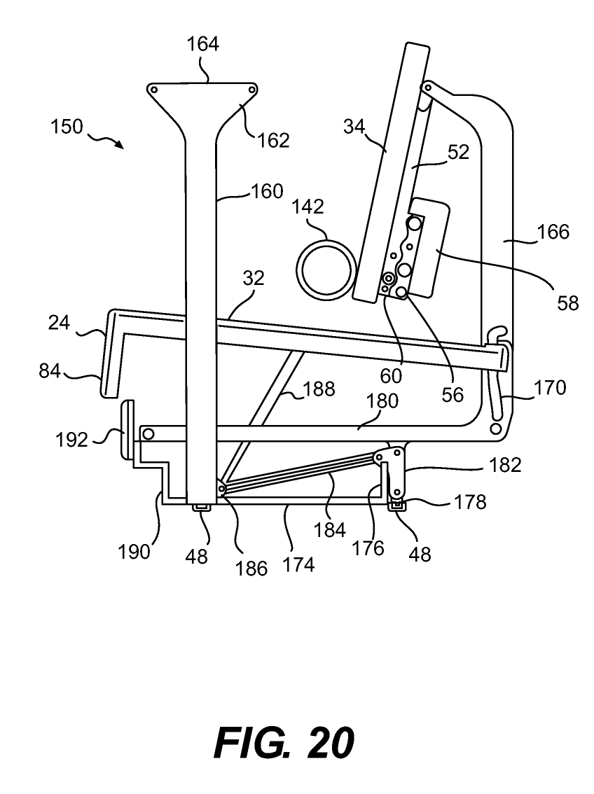

Referring to FIGS. 19 and 20, the divan 150 incorporates a bottom pan 174 that extends from the outboard track 48 to a position inboard of the inboard track 48. The rear 176 of the bottom pan 174 is disposed adjacent to (and/or connected to) rear legs 178. The vertical frame element 166 is connected to a seat frame element 180. In this embodiment, the seat frame element 180 is integrally molded with the vertical support 166. However, it is contemplated that the vertical frame element 166 may be separated from the seat frame element 180.

A bracket 182 connects to the leg 178. A connector 184 extends between the bracket 182 and an eyelet 186 on the upright 160. A seat support 188 extends from the location of the eyelet 186 to a position beneath the seating surface 32. The seating support 188 supports the seat in at least the seating position by maintaining the seating surface 32 at a suitable height above the floor 14.

The backrest 34 is supported on a backrest frame element 52, as in the previous embodiments. An extension surface 58 is connected to an extension frame element 56. The extension frame element 56 is connected to the backrest frame element 52 at an extension pivot point 60. The divan 150 includes a bolster pillow 142, as in the previous embodiment.

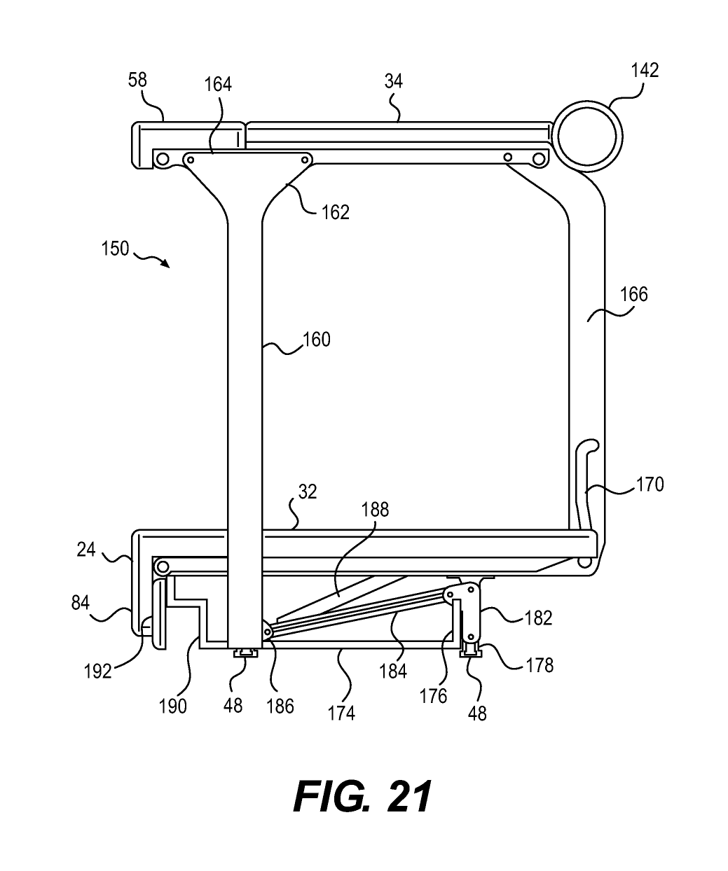

As is apparent from FIG. 20, the front 190 of the bottom pan 174 includes a stepped shape to create an area into which a person's toes may be disposed when approaching the divan 150. A moveable wall 192 is positioned adjacent to the front end 190 of the bottom pan 174. The moveable wall 192 moves vertically from the position illustrated in FIG. 20 to the position illustrated in FIG. 21. In this manner, the moveable wall 192 provides a cover over the gap between the drop down 84 and the front end 190 of the bottom pan 174.

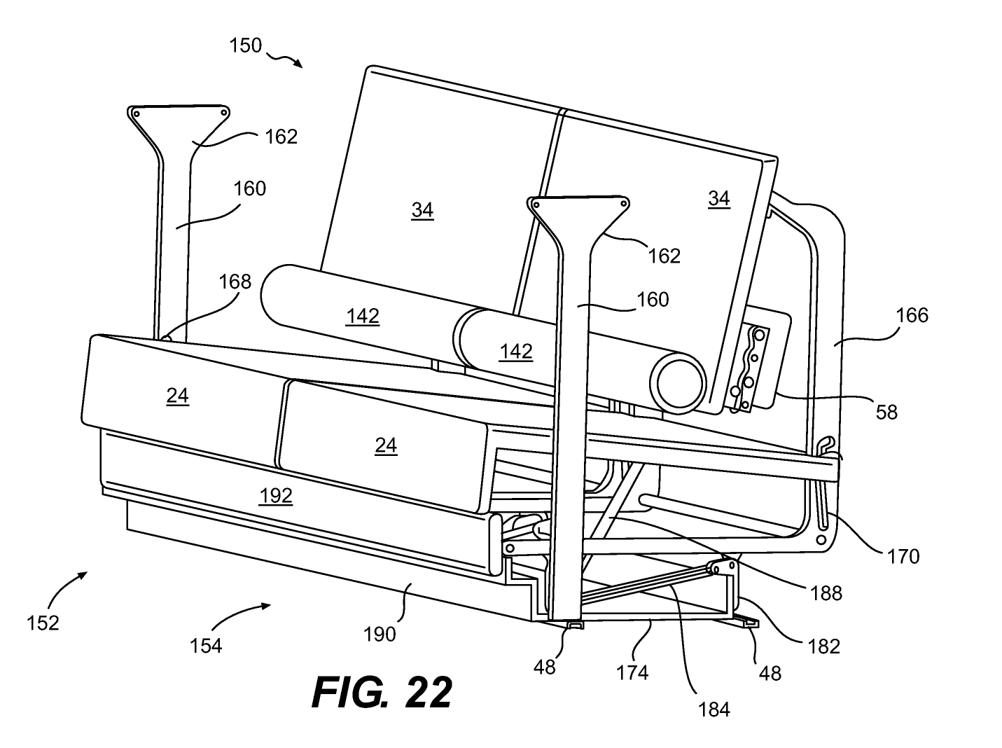

FIG. 22 is a perspective illustration of the divan 150 when configured in the seating orientation.

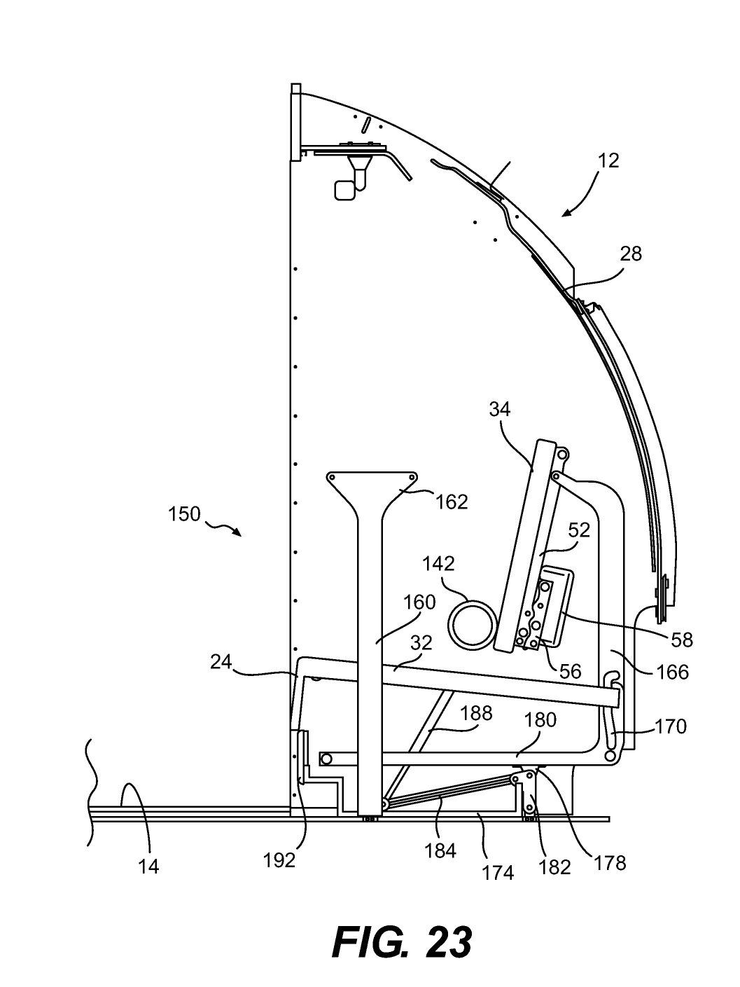

FIG. 23 provides a side view of the divan 150 within the interior of an aircraft 12. Here, the divan 150 is shown in the seating configuration.

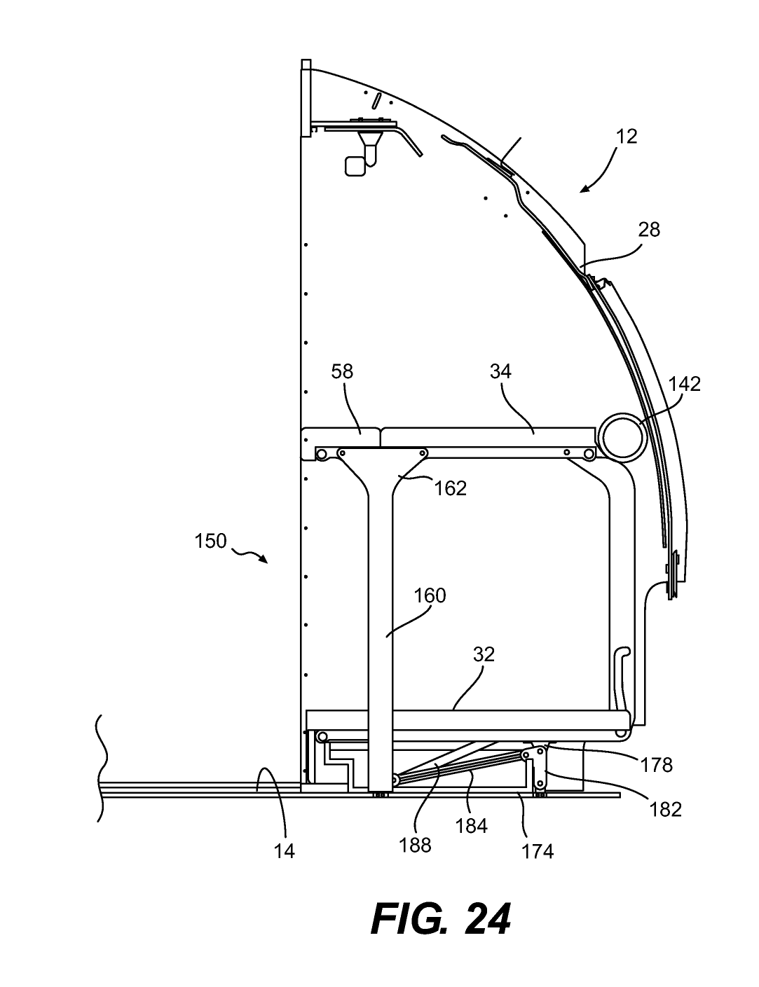

FIG. 24 is a side view of the divan 150 in the interior of an aircraft 12. In this illustration, the divan 150 is shown in the bunk bed (or second) configuration.

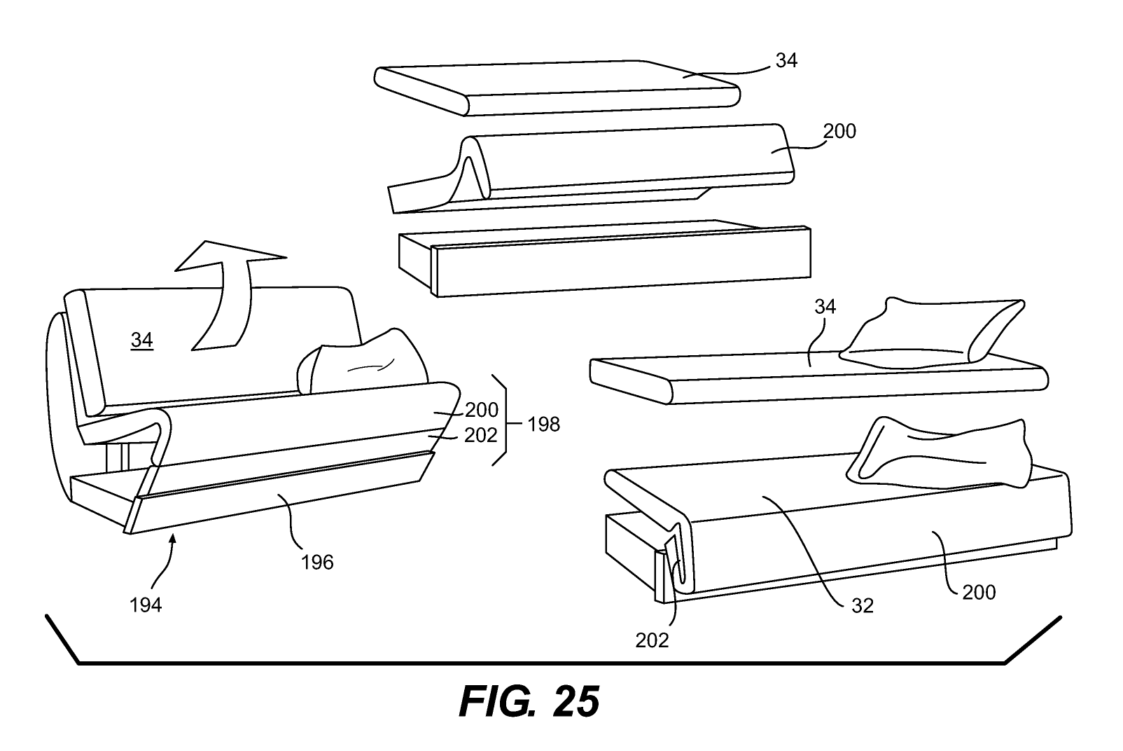

FIG. 25 is a three-part illustration of a further aspect of the present invention. Here, the divan 194 includes a front 196 with a foldable section 198 having upper and lower segments 200, 202. When the divan 194 is in the seating configuration, the upper and lower segments 200, 202 form the drop down for the front 196 of the divan 194.

When the divan 194 is configured in the bunk bed configuration, the lower segment 202 is folded behind the upper section 200. The upper section 200, therefore, defines the front of the divan 194 in the bunk bed configuration.

It is noted that the divans 10, 120, 136, 150, and 194 of the present invention are contemplated to be manually operated. In other words, these embodiments are designed to operate mechanically, with the assistance of one or more persons.

While a manual operation is contemplated for the divans 10, 120, 136, 150, and 194 of the present invention, the present invention is not intended to be limited thereto. It is contemplated that the divan 10, 120, 136, 150, 194 of the present invention may be operated via a motorized construction. Alternatively, a pneumatic operation may be employed. The divans 10, 120, 136, 150, 194 of the present invention may be automated in still other ways without departing from the scope of the present invention.

With respect to the divans 10, 120, 136, 150, and 194, there are two additional variations that are contemplated.

In one of the variations, it is contemplated that the backrest 34, when in the bunk bed configuration, may be provided with one or more supports that extend from underneath the backrest frame element 52 to the vertical frame element 40. These additional supports may take the form of lockable folding supports 204 that connect adjacent to the backrest pivot 54. One example of this type of folding support is provided in FIG. 4, for illustrative purposes. The foldable locking support 204 includes first and second arms 206, 208 that are connected to one another at a folding pivot 210. A folding support 204 may be provided at each vertical support frame 40, as should be apparent to those skilled in the art. It is noted that this folding support 204 is not required to practice the present invention.

The second of the variation applies to embodiments of the divan 10, 120, 136, 150, 194 that rely on multiple divan units being disposed in a side-by-side arrangement. So that these separate divan units are secured to one another in one or both of the first and second configurations, a locking member 212 may be provided between. One example of a locking member 212, such as a slidable bolt, is illustrated in FIG. 8. As should be apparent to those skilled in the art, any other suitable locking member 212 may be employed without departing from the scope of the present invention. The locking member 212 is intended to be illustrative of one contemplated embodiment. It is noted that the locking bolt 212 may slide in the direction of arrows 214 so that the divan units may be releasably connected to one another. This variation also is considered an optional feature and, therefore, is not required to practice the present invention.

As noted above, the present invention is not intended to be limited to any of the embodiments described herein. To the contrary, the enumerated embodiments are intended to be exemplary of the scope of the present invention. In addition, it is noted that features from one embodiment of the present invention may be incorporated into other embodiments, interchangeably, without departing from the scope of the present invention.

What is claimed is:

1. A divan, comprising:
a seating surface; and
a backrest;
wherein, in a first configuration, the backrest is positioned adjacent to the seating surface to support a person's back while the person is seated on the seating surface;
wherein, in the first configuration, the seating surface is disposed at a first predetermined height above a horizontal plane;
wherein, in a second configuration, the backrest establishes an upper bunk above the seating surface;
wherein, in the second configuration, the seating surface establishes a lower bunk beneath the upper bunk; and
wherein, in the second configuration, the seating surface is disposed at a second predetermined height that is lower than the first predetermined height.

2. The divan of claim 1, further comprising:
a vertical frame element, with top and bottom ends, disposed adjacent to the seating surface and the backrest,
wherein the backrest is pivotally connected adjacent to the top end of the vertical frame element, and
wherein the seating surface is slidably connected adjacent to the bottom end of the vertical frame element.

3. The divan of claim 2, wherein the seating surface also is pivotally connected adjacent to the bottom end of the vertical frame element.

4. The divan of claim 2, further comprising:
an extension surface pivotally connected to the backrest, wherein the extension surface is lockable into a position adjacent to the backrest to increase a width of the backrest when in the second configuration.

5. The divan of claim 1, wherein, in the first configuration:
the backrest forms a first angle with respect to the horizontal plane;
the seating surface forms a second angle with respect to the horizontal plane; and
the first and second angles are greater than or equal to 0 degree.

6. The divan of claim 1, wherein, in the second configuration:
the backrest is parallel to the horizontal plane; and
the seating surface is parallel to the horizontal plane.

7. The divan of claim 1, further comprising:
a seating frame supporting the seating surface;
a lower frame positioned adjacent to the seating frame; and
a scissor connecting the seating frame to the lower frame, thereby permitting transition of the seating surface between the first configuration and the second configuration.

8. The divan of claim 7, wherein:
the scissor comprises a first scissor element with a first end and a second end and a second scissor element with a third end and a fourth end;
the first and second scissor elements are pivotally connected to one another at positions intermediate to the first and second and third and fourth ends, respectively;
the first end is pivotally connected to the seating frame;
the second end is pivotally and slidingly connected to the lower frame;
the third end is pivotally and slidingly connected to the seating frame; and
the fourth end is pivotally connected to the lower frame.

9. The divan of claim 1, further comprising;
at least one bracket disposed at a predetermined height such that the bracket supports the upper bunk when in the second configuration.

10. The divan of claim 7, further comprising:
a plurality of legs supporting the lower frame.

11. The divan of claim 10, wherein the plurality of legs are connected to seating tracks disposed within a floor of an aircraft cabin.

12. A divan, comprising:
at least two seating surfaces disposed adjacent to one another in a side-by-side arrangement; and
at least two backrests disposed adjacent to one another in a side-by-side arrangement;
wherein, in a first configuration, the backrests are positioned adjacent to the seating surfaces to support a person's back while the person is seated on at least one of the seating surfaces;
wherein, in the first configuration, the seating surfaces are disposed at a first predetermined height above a horizontal plane;
wherein, in a second configuration, the backrests establish an upper bunk above the seating surfaces;
wherein, in the second configuration, the seating surfaces establish a lower bunk beneath the upper bunk; and
wherein, in the second configuration, the seating surfaces are disposed at a second predetermined height that is lower than the first predetermined height.

13. The divan of claim 12, further comprising:
at least two vertical frame elements, with top and bottom ends, disposed adjacent to the seating surfaces and the backrests,
wherein the backrests are pivotally connected adjacent to the top ends of the vertical frame elements, and
wherein the seating surfaces are slidably connected adjacent to the bottom ends of the vertical frame elements.

14. The divan of claim 13, wherein the seating surfaces also are pivotally connected adjacent to the bottom end of the vertical frame element.

15. The divan of claim 13, further comprising:
an extension surface pivotally connected to each backrest, wherein each extension surface is lockable into a position adjacent to each backrest to increase a width of each backrest when in the second configuration.

16. The divan of claim 12, wherein, in the first configuration:
the backrests form a first angle with respect to a vertical line perpendicular to the horizontal plane;
the seating surfaces form a second angle with respect to the horizontal plane; and
the first and second angles are greater than or equal to 0 degree.

17. The divan of claim 12, wherein, in the second configuration:
the backrests are parallel to the horizontal plane; and
the seating surfaces are parallel to the horizontal plane.

18. The divan of claim 12, further comprising:
a seating frame supporting each seating surface;
a lower frame positioned adjacent to each seating frame; and
at least two scissors connecting each seating frame to each lower frame, thereby permitting transition of the seating surfaces between the first configuration and the second configuration.

19. The divan of claim 18, wherein:
the scissors each comprise a first scissor element with a first end and a second end and a second scissor element with a third end and a fourth end;
the first and second scissor elements are pivotally connected to one another at positions intermediate to the first and second and third and fourth ends, respectively;
the first end is pivotally connected to the seating frame;
the second end is pivotally and slidingly connected to the lower frame;
the third end is pivotally and slidingly connected to the seating frame; and
the fourth end is pivotally connected to the lower frame.

20. The divan of claim 12, further comprising;
at least two brackets disposed at a predetermined height such that the brackets support the upper bunk when in the second configuration; and
an upper bunk connector to connect the seating surfaces to one another when in the second configuration.

21. The divan of claim 18, further comprising:
a plurality of legs supporting each of the lower frames.

22. The divan of claim 12, wherein the plurality of legs are connected to seating tracks disposed within a floor of an aircraft cabin.
